(19) United States
(12) Patent Application Publication
(10) Pub. No.: US 2009/0233507 A1
(43) Pub. Date: Sep. 17, 2009

(54) Fabric treatment process

(76) Inventors: Alexander L. Gross, Aspen, CO (US); Richard Lauren Edwards, San Diego, CA (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/291,831

(22) Filed: Nov. 12, 2008

Related U.S. Application Data
(60) Provisional application No. 60/987,272, filed on Nov. 12, 2007.

(51) Int. Cl. B32B 5/02; B05D 3/00; C09D 7/00; D06M 13/08; C11D 3/24

(52) U.S. Cl. 442/82; 427/394; 442/94; 106/287.27; 252/8.62; 252/8.63; 252/8.91; 510/400; 510/520; 510/522; 510/278; 510/299; 510/276

(57) ABSTRACT

The present invention is directed to a process for improving at least one of the water-resistance, stain resistance, and/or oil resistance of a fabric by treating the fabric with a composition comprising a wetting-agent, a fluorocarbon repellant, and a carrier.

### CROSS-REFERENCE TO RELATED APPLICATIONS

This application claims the benefit of the filing date of U.S. Provisional Patent Application No. 60/987,272 filed Nov. 12, 2007, the disclosure of which is hereby incorporated herein by reference.

### BACKGROUND OF THE INVENTION

The most popular material for clothing and other garments is cotton, present in about 84% of the world's garments. It can be said that the T-shirt and blue-jeans combination represents the world's most popular “uniform.” In fact, today, blue-jeans are the de-facto clothing standard, whether they are paired with a sport-coat for an elegant evening on the town or worn on the ski and snowboarding slopes in lieu of snow pants.

The problem with cotton, and most other natural and synthetic fabrics, is that they are not water-resistant. As used herein “water-resistant” it is meant that the fabric can withstand penetration to water, bodily fluids, and any dissolved or suspended foreign matter or material contained in liquid droplets or spray, for longer than untreated fabrics.

Known waterproofing methods include spraying various water-proofing compositions topically onto a fabric, and typically directly to the finished garment. Such topical application is not durable and certainly cannot be trusted in mission-critical applications (e.g. military clothing, athletic clothing, swimsuits, wetsuits, medical clothing, etc.).

Siloxanes are known as water repellents for textile and hard surfaces. However, many of these compositions do not work well on cotton or polycotton fibers, and are not durable. They may require large doses in order to cover the fabric due to their inefficient absorption on textiles. Several companies produce siloxanes for potential use as water repellants or soil releasing agents.

Aftermarket products sold for adding repellency may be provided as an aerosol application. Some examples of such products include: Scotchgard® brand products, Kiwi Camp Dri®, Rivivex™ (which includes a curing step in the dryer), Blue Magic Tectron Wet Guard™, and Nikwax TX™. These products are marketed primarily as water repellants and soil repellents to provide or restore repellency on outerwear or shoes. They may be delivered via a solvent or water dispersion aerosol.

A minority of aftermarket products are marketed using a wash-in application. These include Nikwax TX™, which provides for a direct wash-application for the restoration of a durable water-repellency) and Storm Proofer Plus “Rudolf”™, a stain and abrasion resistant finish based on a water dispersed hydrocarbon. ReviveX Wash-in™ water repellent is suggested for use with outerwear, and Granger wash-in waterproofing is provided for restoring repellency to a factory applied finish.

Consumers desire to protect their fine textile and fabric-based products from excessive dirt, wear, and moisture. Thus, compositions or treatments methods that may be applied to consumer articles or fabrics to repel dirt or moisture, or to preserve the appearance of such articles, are highly desirable.

To meet today's active and casual lifestyles, compositions and processes for applying them are needed to provide at least partial water-resistance to fabrics and garments, while maintaining the garment's natural feel, comfort, durability, aesthetics, breathability (i.e., air and vapor permeability), and fashionability. In addition to the foregoing, such a composition and/or process must allow for repeated abuse from the environment, the wearer and laundering.

### SUMMARY OF THE INVENTION

One aspect of the present invention is directed to a process for treating a fabric comprising the steps of applying a composition to a fabric, the composition comprising a wetting-agent, a fluorocarbon repellant, and a carrier; and b) curing the composition at a temperature ranging between about 240° F. and 430° F.; wherein an amount of the composition is applied such that the fabric gains between about 1% and about 18% in weight.

In another aspect of the present invention is directed to a process for treating a fabric comprising the steps. of a) applying a composition to a fabric at a temperature ranging between about 100° F. and about 212° F.; the composition comprising a wetting-agent, a fluorocarbon repellant, and a carrier, the wetting-agent is present in an amount of between about 0.01% and about 15% by weight of the composition, and the fluorocarbon repellant is present in an amount between about 2% to about 30% by weight of the composition; and b) curing the composition at a temperature ranging between about 240° F. and 430° F.; wherein an amount of the composition is applied such that the fabric gains between about 1% and about 18% in weight.

In another embodiment of the present invention, the amount of wetting agent is less than 15% by weight of the composition. In another embodiment of the present invention, the amount of wetting agent is less than 10% by weight of the composition. In another embodiment, the amount of wetting agent is between about 0.01% and 15% by weight of the composition. In another embodiment of the present invention, the wetting agent is selected from the group consisting of ionic, nonionic, zwitterionic, and anionic surfactants. In yet another embodiment of the present invention, the wetting agent is a nonionic surfactant. In a further embodiment of the present invention, the wetting agent is a mixture of dipropylene glycol and ethoxylated alcohols.

In another embodiment, the fluorocarbon repellant is a (perfluroalkyl) acrylate. In another embodiment of the present invention, the amount of the fluorocarbon repellant is between about 5% and about 25% by weight of the composition. In another embodiment of the present invention, the amount of the fluorocarbon repellant is between about 8% and about 20% by weight of the composition.

In another embodiment of the present invention, the composition comprises a mixture of dipropylene glycol and ethoxylated alcohols as the wetting agent and a (perfluoroalkyl) acrylate as the fluorocarbon repellant.

In another embodiment of the present invention, the application temperature is between 125° F. and 175° F. In another embodiment, the curing temperature ranges from about 270° F. to about 430° F. In another embodiment of the present invention, curing is performed for a time ranging between about 5 seconds and about 200 seconds. In another embodiment, the curing is performed for about 10 seconds at a temperature of about 392° F.; for about 20 seconds at a temperature of about 374° F.; for about 30 seconds at a temperature of about 356° F.; for about 45 seconds at a temperature of about 338° F.; for about 60 seconds at a temperature of about 320° F.; or for about 180 seconds at a temperature of about 284° F.

In another embodiment, the composition further comprises an additive selected from the group consisting of anti-bacterial agents, UV-absorbing agents, flame retardants, dyes, weak acids, weak bases, and fragrances. The amount of additive present in the composition may range between 0.5% and about 10% by weight of the composition.

In another embodiment of the present invention, the fabric is a fiber, filament, fibrous pulp, yarn, cloth, and finished garment.

In another embodiment of the present invention, the treated fabric passes-through less than 5% of water when subjected to a water-resistance test.

Another aspect of the present invention is a composition comprising a wetting agent, a fluorocarbon repellant, and a carrier, wherein said wetting-agent is present in amount of less than about 15% by weight of the composition, and the fluorocarbon repellant is present in an amount between about 2% to about 30% by weight of the composition. In another embodiment, the composition is a carpet cleaner, laundry detergent, drier sheets, fabric softener, anti-static spray, or wrinkle-resistant spray.

Another aspect of the present invention is a product treated with a composition comprising a wetting agent, a fluorocarbon repellant, and a carrier, wherein said wetting-agent is present in amount of less than about 15% by weight of the composition, and the fluorocarbon repellant is present in an amount between about 2% to about 30% by weight of the composition; and wherein the product has at least one of improved water resistance, stain resistance, and soil resistance. In another embodiment, the treated product passes-through less than 5% of water when subjected to a water-resistance test. The product is selected from the group consisting of running tights, shorts, t-shirts, tank tops, leotards, denim jeans, thermals, hosiery, gloves, hats, socks, sneakers, military uniforms, medical scrubs, lab coats, jackets, pants, hats, and shoes.

Yet another aspect of the present invention is an additive for use in treating a fabric comprising a wetting agent, a fluorocarbon repellant, and a carrier, wherein the wetting-agent is present in amount of less than about 15% by weight of the composition, and the fluorocarbon repellant is present in an amount between about 2% to about 30% by weight of the composition. The additive may be combined with a carpet cleaner, laundry detergent, drier sheets, fabric softener, anti-static sprays, and wrinkle-resistant sprays or liquids.

It has unexpectedly been found that the composition of the present invention, when applied to a fabric, can improve at least one of water-resistance, stain resistance, or oil resistance to a fabric even after repeated wear and laundering. Moreover, it has been found that the fabrics and/or finished garments maintain their breathability and aesthetics after treatment.

### DETAILED DESCRIPTION

The present invention is directed to a fabric treatment process for improving at least one of water resistance/repellency, stain resistance, and/or stain release properties. “Water repellency” or “water resistance”, used interchangeably, is defined as the ability of a substrate to at least partially block water. Thus, the present invention also provides a method of preventing substances dissolved or suspended (e.g. blood constituents, soil/mud, emulsified oil) in the water from penetrating and/or staining the fabric. It is believed that this is accomplished by preventing liquids from wetting or spreading on the substrate. The. liquids, therefore, will not have the opportunity for significant absorption and staining.

The improvement in water resistance can be tested by measuring the amount of water passing-through an 8″×8″ swatch of fabric after the swatch is subjected to a spray or jet of water at a rate of about 1.5 gallons (192 ounces) per minute (herein after referred to as a “water-resistance test”). Improvement in water resistance is observed if less than 5% of the water is allowed to pass-through the swatch. In some embodiments, water resistance is observed if less than 3% of water is allowed to pass-through the swatch. In other embodiments, water resistance is observed if less than 2% of water is allowed to pass-through the swatch. In yet other embodiments, water resistance is observed if less than 1% of water is allowed to pass-through the swatch. A Bundesmann Water Repellency Tester may used to determine the water resistance.

Similarly, stain resistance means an oil repellency rating of at least 3.0 when tested by AATCC Test Method 118-2000, or a water repellency rating of at least 1.0 when tested by the 3M Water Repellency Test I1 (May, 1992). “Improved stain resistance” or “improved stain release” means a rating for corn oil and mineral oil release of at least 3.0 when tested by AATCC.

More specifically, the invention is directed to a process for treating a fabric with a composition comprising a wetting-agent, a fluorocarbon repellant, and a carrier to improve at least one of the aforementioned properties. Besides its common definition, the term “fabric” as used herein could also mean a finished garment produced from a fabric, or the basic elements that make up a fabric, i.e. the fabric's constituent components such as the individual fibers, pulp, filaments, and yarns. The fabrics of the present invention may be woven or non-woven and dyed or undyed. Thus, the process can be used to treat one or all of the fibers, the cloth made from it, and the garment made from the cloth.

The process may be applied to natural fabrics, synthetic fabrics, and blends of natural and synthetic fabrics. The term “natural fabrics” means those fabrics whose constituent fibers or elements are derived from plant and/or animals (e.g. animal hair or fur). Examples of natural fabrics include cotton, wool, angora, silk, grass, rush, hemp, sisal, coir, straw, bamboo, pina, ramie, and seaweed.

The term “synthetic fabrics” means those fabrics whose constituent fibers or elements are derived from polymer-based materials. Examples of such polymer-based materials include polyamide (nylon), polyester, aramid, or other spun thermoplastics. Examples of synthetic fabrics include polyester, aramid, acrylic, nylon, spandex, olefin fibre, ingeo (a polylactide), and lurex.

Fabric blends include those having mixtures of natural and synthetic fibers.

The treatment process includes the step of applying a composition to the fabric. The water proofing composition is comprised of a wetting agent, a repellant, and a carrier.

The wetting agent is selected from ionic, non-ionic, zwitterionic, and anionic agents capable of lowering the surface tension of a liquid (e.g. detergents, surfactants, etc.). In some embodiments, a wetting agent is selected that is capable of absorbing or accepting a dye.

Suitable wetting agents include, without limitation, those available from Clariant® (Textile, Leather & Paper Chemicals Division Rothausstrasse 61, 4132 Muttenz, Switzerland) and sold under the tradenames Pentex™ (e.g. Pentex™ AS, nonionic/anionic scouring agent and emulsifier; Pentex FC, a nonionic non-rewetting wetting agent comprising a mixture of dipropylene glycol and ethoxylated alcohols; Pentex OS-NF, a nonionic scouring agent; Pentex PBR, an anionic penetrant), Raycapol™ (e.g. Raycapol® OE-M, a nonionic scouring agent), Sandoclean™ (e.g. Sandoclean® CW, a nonionic wetting agent; Sandoclean PC, a nonionic wetting agent), and Sandopan™ (e.g. Sandopan® CLF, an anionic wetting agent; Sandopan DTC-100 MM, an anionic wetting agent; Sandopan NF, a nonionic non-foaming detergent). Other wetting agents include Burcowet 500 available from Daikan (address); Dowfax 2A1, an alkyldiphenyloxide disulfonate dispersant emulsion stabilizer, available from Dow (The Dow Chemical Company, 2030 Dow Center, Midland, Mich. 48674 ); and Invadine PBN, a wetting agent for pretreatment of textiles, available from Huntsman Chemical (Huntsman LLC, Corporate Office, 10003 Woodloch Forest Drive, The Woodlands, Tex. 77380).

In some embodiments, the wetting agent is a non-ionic wetting agent.

In some embodiments, amount of wetting agent in the composition to be applied is between about 0.01% and about 15% by weight of the composition. In other embodiments, the amount of wetting agent in the composition to be applied is less than about 15% by weight of the composition. In yet other embodiments, the amount of wetting agent in the composition is less than about 10% by weight of the composition.

The repellant is a fluorocarbon-based chemical. The terms “fluorocarbon-based chemical”, “fluorocarbon repellant, “fluorochemical,” and “fluoropolymer”, used interchangeably, means a chemical, polymer, or copolymer material containing at least one fluorinated segment. A fluorochemical is defined as an organic molecule (including oligomers, polymers and dendritic structures) which contain significant fluorine substituents (between 4-30% based on solids) so as to lower their surface tension (neat or in a water dispersion) below 30 mN/m.

Various fluorochemicals have been developed for application to fabrics to impart water and oil repellency (as well as soil resistance) thereto. These fluoropolymers may be referred to as repel type fluorochemicals. Non-limiting, compounds of this type include Repeal® F-35, Repeal® 7005, SR-1100, Repearl® F8025, and Repearl® F-89, all available from Mitsubishi Corp., as well as Zonyl® 7713 and 7790, available from DuPont. Treatment of a substrate with a hydrophobic stain repellency agent generally results in a surface that exhibits a low surface energy. Other preferred repel type fluorochemicals include fluorinated acrylates, fluorinated urethanes, and fluorinated dendrimers that are typical to the textile finishing industry.

Examples of other suitable fluorocarbon based repellants include NUVA™ 2110 (a (perfluoroalkyl) acrylate), available from Clariant; TG-581, TG-995, and TG-992 available from Daikan America (20 Olympic Drive, Orangeberg, N.Y. 10962); Milease F-14 and F-31X available from Croda (Croda Inc. 300-A Columbus Circle, Edison, N.J. 08837); Phobotex FC series available from Ciba (Ciba Specialy Chemicals, Inc., P.O. Box CH-4002 Basel); Invista also available from DuPont; NUVA CPA and HPU also available from Clariant.

In other embodiments, fluorochemicals useful in this invention comprise fluorochemical compounds or polymers containing one or more fluoroaliphatic groups R_{f}, which are fluorinated, stable, inert, non-polar, preferably saturated, monovalent and both bleophobic and hydrophobic. R_{f} preferably contains at least about 3 carbon atoms, more preferably 3 to about 20 carbon atoms, and most preferably about 4 to about 14 carbon atoms. R_{f} can contain straight chain, branched chain, or cyclic fluorinated alkylene groups or combinations thereof or combinations thereof with straight chain, branched chain, or cyclic alkylene groups. R_{f} is preferably free of polymerizable olefinic unsaturation and can optionally contain heteroatoms such as oxygen, divalent or hexavalent sulfur, or nitrogen. It is preferred that R_{f} contain about 40% to about 78% fluorine by weight, more preferably about 50% to about 78% fluorine by weight. The terminal portion of the R_{f} group contains a fully fluorinated terminal group. This terminal group preferably contains at least 7 fluorine atoms, e.g., CF₃ CF₂ CF₂—, (CF₃)₂ CF—, —CF₂ SF₅, or the like. Perfluorinated aliphatic groups (i.e., those of the formula CnF₂ₙ₊₁) are the most preferred embodiments of R_{f}.

Generally, the amount of repellant in the composition ranges from about 2% to about 30% by weight of the composition. In some embodiments, the amount of repellant ranges from between about 5% to about 25% by weight of the composition. In other embodiments, the amount of repellant ranges from between about 8% to about 20% by weight of the composition. In yet other embodiments, the amount of repellant ranges from between about 8% to about 15% by weight of the composition.

The carrier is selected from water and other suitable organic solvents. One skilled in the art will be able to select and appropriate carrier which is compatible with the wetting-agent, the repellant, other additives which may be included, and, of course, the fabric to which it is applied.

The water proofing composition may also comprise additives. Such additives include anti-bacterial agents, UV-active/absorbing agents, flame-retardants, dyes, and fragrances. The compositions may also comprise acids and/or bases to adjust the pH/alkalinity of the composition. Additives may be present in an amount ranging from about 0.5% to about 10% by weight of the composition.

Depending on the other additives used and/or dyes used, it may be necessary to control the pH and alkalinity of the composition. To achieve this pH adjustment, one or more weak acids or weak bases are added to the composition. It has been discovered that a pH of between 3.8 and 5.0 and a maximum alkalinity of 0.1% is best when indigo dye is used (whether the indigo dye is mixed in as part of the composition or added before or after application of the composition). While any weak acid may be used to lower the solutions pH this purpose, it has been found that acetic acid and/or citric acid work best.

In some embodiments, the composition is applied at room temperature, i.e. between about 65° F. and about 78° F. In other embodiments, the composition is applied at elevated temperatures, i.e. above room temperature. In yet other embodiments, the composition is applied at temperature between about 100° F. and about 212° F. In yet further embodiments, the composition is applied at a temperature between about 125° F. and about 175° F.

Without wishing to be bound by any one particular theory, it is believed that applying the composition at an elevated temperature helps to impregnate the composition into the fabric and, in particular, allows the composition to reach and accumulate in the spaces between the individual fibers.

The application of the composition may be accomplished by any method known in the art, including dipping, immersion (with or without additional agitation), printing, and coating by “lick rollers.” In some embodiments, the composition is applied by an Izumi Unisizer KS-3 Coating Winder, a Bates Y.C.B. coater and bonder, a USI prism ultrasonic spray coating system, a Glenro Monofilament yarn coating system model 11136, a Compuplast Module system, and by the methods described in U.S. Pat. No. 4,307,497, the disclosure of which is hereby incorporated by reference herein. One skilled in the art will be able to determine an appropriate application process depending of the type of fabric being used and the size and shape of the material being treated.

One skilled in the art will be able to determine the appropriate length of time to immerse the fabric into the composition or the number of times the fabric is dipped and held in the composition. For example, the fabric is generally immersed in the composition for a period ranging from about 1 minute to about 5 minutes. Of course, different materials have different. absorption characteristics and, thus will require longer or shorter application times.

In general, an amount of composition must be applied so as to make the fabric at least partially water-resistant and/or stain-resistant. Application of too much composition could cause the fabric to become too stiff.

The amount of composition applied to the fabric can be quantified by determining a weight gain in the fabric, by measuring the dry weight of the fabric both before and after curing (i.e. measure the dry fabric before application and again measure the dry fabric, which is substantially free from carrier, after drying and curing). The difference is the amount by weight of composition adhered onto or into the fabric. More specifically, the amount of composition added to a fabric is that amount which causes a weight gain of between about 1% to about 25%. In some embodiments, the weight gain is between about 2% and about 18%.

Once the composition is applied to the fabric, the fabric must be at least substantially dried and then cured. Drying may be accomplished at room temperature (i.e., 65° F. to 78° F.) or at elevated temperatures (above room temperature) and is dependent on the carrier and other components present in the compositions. Dry air streams, microwave heating, or conventional convention driers may be utilized to further facilitate drying. No set time is required for drying, provided that at least about 80% of the carrier is removed prior to curing.

Curing of the composition is accomplished at an elevated temperature, preferably at a temperature ranging between about 240° F. and about 430° F., and more preferably at a temperature ranging between about 270° F. and about 410° F.

The curing can be performed for any duration provided that neither the fabric nor the composition is damaged or altered, i.e. burned, scorched, shrunk, etc. Typically, the composition is cured for a period of time ranging between about 5 seconds and about 200 seconds.

One skilled in the art will be able to determine the appropriate temperature and time for curing any particular fabric or fabric blend. Depending on the fabric used, the following approximate times and temperatures can be used during the curing phase:

| | |
|---|---|
| 10 seconds | 392° F. |
| 20 seconds | 374° F. |
| 30 seconds | 356° F. |
| 45 seconds | 338° F. |
| 60 seconds | 320° F. |
| 180 seconds | 284° F. |

The above-mentioned application may be applied to either pre-dyed fabrics or undyed fabrics. Of course, dye may be applied contemporaneously with the application of the composition, either as part of the composition itself (an additive), or separately after application and/or curing of the composition. Of course, and in particular for the case of denim, if the fabric is to be treated with the composition prior to dyeing, it is important that a wetting agent be selected that leaves enough dye sites available for indigo dye penetration.

The composition is applied at least once to a fabric, i.e. applied at the stage of fibrous particles and/or yarn and/or woven fabric and/or finished garment. For example, the composition may be. applied to the fibers which are made into a yarn, and then applied again to the yarn.

Similarly, the composition may be applied more than once to any one particular fabric. For example, the water-proofing composition may be applied a first time to a yarn followed by curing and then a second time to the same yarn, and again followed by curing. One skilled in the art will be able to determine, depending on the amount of desired the appropriate amounts of composition and appropriate number of applications to yield the desired product or amount of. For example, military uniforms require a higher level of protection, than, for example, consumer tee shirts.

Also disclosed are fabrics which have been treated in accordance with the processes described above. These fabrics, which have been pre-treated, may be formed into various apparel. Accordingly, disclosed are fibers, yarns, fabrics, and finished garments treated in accordance with the aforementioned process.

Also disclosed are products, including garments, comprising a fabric which has been treated in accordance as described above. The term “garment” is means any item that is worn by the user to protect some region of the user's body from weather or other factors in the environment outside the body. For example coats, jackets, pants, hats, shoes, socks, uniforms, jumpsuits, and shirts would all be considered garments under this definition.

Products which are particularly suited for such treated fabrics include athletic garments which are worn during athletic activities, garments for the military, and garments used by medical professionals. Other examples of products include running tights, shorts, t-shirts, tank tops, leotards, denim jeans, thermals, hosiery, gloves, hats, socks, sneakers, rain coats, snow gear, medical scrubs, and lab coats.

The fabric may also be used in the manufacture of a variety of non-apparel applications, such as blankets, backpacks/book bags, equipment cases, luggage, medical wraps and braces.

The composition of the present invention may also be included in a number of commercial products as an additive. For example, carpet cleaning products and other similar products may include the composition of the present invention as an additive which imparts at least partial water-resistance and/or stain-resistance to the object being cleaned or otherwise treated. Moreover, the composition may be combined as an additive in laundry detergent, drier sheets, fabric softener, anti-static sprays, and wrinkle resistance sprays, liquids, or solutions. In general, other commercial products may contain between about 5% and about 60% of the composition of the present invention as an additive.

### EXAMPLE

An 8′×8′ swatch of 100% cotton denim fabric was weighed and then was immersed into a composition comprising about 90% water, about 10% fluorochemical repellant (NUVA™ 2110), and about 1% wetting agent (Pentex FC) for about to about 3 minutes. The composition was applied at a temperature of about 140° F. When removed, the swatch was wrung out to remove excess solution and then dried for about 4.5 minutes in a microwave oven (alternatively, the swatch could have been dried in a conventional oven for about 20 minutes). The swatch was then cured on an oven hot plate at about 410° F. degrees for about 30 seconds. When weighed (by difference), it was determined that the swatch gained about 8% in weight, which accounts for the composition applied.

The swatch was then prepared for “rain testing,” as follows. The swatch was clamped over a glass beaker. A spray/jet of about 1.5 gallons (192 ounces) of water was focused at a 90 degree angle onto the swatch for a period of about one minute. Then the swatch was removed from the beaker, and any pass-through of water (leakage) was carefully measured. The material satisfactorily prevented water from passing-through (success being determined by passing-through about 1 ounce of water or less).

The swatch was then submitted to hot water wash/dry durability testing. The swatch was placed in a washing machine with 1 ounce of standard laundry detergent. The washing machine was set for “hot water,” i.e. water having a temperature of about 165° F. and “spin dry.” When the was cycle was completed, the swatch was placed in a laundry dryer for about 20 minutes and set to hot, i.e. having a temperature of about 160° F.

When the wash/dry cycle was completed, the swatch was resubmitted to the aforementioned “rain test.” The rain/durability testing was repeated 50 times, at which time this particular composition for this particular purpose “failed”, i.e. more than 1 ounce of water penetrated the fabric during rain testing.

It was not expected that a swatch of material treated with the composition of the present invention would have withstood such repeated rain/durability testing. For example, Scotchguard applied topically to a similar swatch of material failed the test after the first wash cycle.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A process for treating a fabric comprising the steps of:
a) applying a composition to a fabric at a temperature ranging between about 100° F. and about 212° F.; said composition comprising a wetting-agent, a fluorocarbon repellant, and a carrier, said wetting-agent is present in an amount of less than about 15% by weight of the composition, and said fluorocarbon repellant is present in an amount between about 2% to about 30% by weight of the composition; and
b) curing said composition at a temperature ranging between about 240° F. and 430° F.;
wherein an amount of said composition is applied such that said fabric gains between about 1% and about 18% in weight.

2. The process of claim 1, wherein said amount of said wetting agent is less than about 10% by weight of said composition.

3. The process of claim 1, wherein said amount of said wetting agent ranges from between about 0.01% to about 15% by weight of said composition.

4. The process of claim 1, wherein said wetting agent is selected from the group consisting of ionic, nonionic, zwitterionic, and anionic surfactants.

5. The process of claim 1, wherein said amount of said fluorocarbon repellant is between about 5% and about 25% by weight of said composition.

6. The process of claim 1, wherein said amount of said fluorocarbon repellant is between about 8% and about 20% by weight of said composition.

7. The process of claim 1, wherein said application temperature is between 125° F. and 175° F.

8. The process of claim 1, wherein said curing temperature ranges from about 270° F. to about 430° F.

9. The process of claim 8, wherein said curing is performed for a time ranging between about 5 seconds and about 200 seconds.

10. The process of claim 1, wherein said composition further comprises an additive selected from the group consisting of anti-bacterial agents, UV-absorbing agents, flame retardants, dyes, weak acids, weak bases, and fragrances.

11. The process of claim 10, wherein said additive is present in an amount of between about 0.5% and about 10% by weight of said composition.

12. The process of claim 1, wherein said fabric is a fiber, filament, fibrous pulp, yarn, cloth, and finished garment.

13. The process of claim 1, wherein said treated fabric passes-through less than 5% of water when subjected to a water-resistance test.

14. The process of claim 1, wherein said treated fabric passes-through less than 3% of water when subjected to a water-resistance test.

15. A composition comprising a wetting agent, a fluorocarbon repellant, and a carrier, wherein said wetting-agent is present in amount of less than about 15% by weight of said composition, and said fluorocarbon repellant is present in an amount between about 2% to about 30% by weight of said composition.

16. The composition of claim 15, wherein said composition is a carpet cleaner, laundry detergent, drier sheets, fabric softener, anti-static sprays, and wrinkle-resistant sprays.

17. A product treated with a composition comprising a wetting agent, a fluorocarbon repellant, and a carrier, wherein said wetting-agent is present in amount of less than about 15% by weight of said composition, and said fluorocarbon repellant is present in an amount between about 2% to about 30% by weight of the composition; and wherein said product has at least one of improved water resistance, stain resistance, and soil resistance, wherein said composition is applied to said product in an amount such that said product gains between about 1% and about 18% in weight.

18. The product of claim 17, wherein said treated product passes-through less than 5% of water when subjected to a water-resistance test.

19. The product of claim 17, wherein said treated product passes-through less than 3% of water when subjected to a water-resistance test.

20. The product of claim 17, wherein said product is selected from the group consisting of running tights, shorts, t-shirts, tank tops, leotards, denim jeans, thermals, hosiery, gloves, hats, socks, sneakers, military uniforms, medical scrubs, lab coats, jackets, pants, hats, and shoes.
